(19) United States
(12) Patent Application Publication
(10) Pub. No.: US 2023/0334499 A1
(43) Pub. Date: Oct. 19, 2023

(54) MANAGING SOFTWARE SERVICE LIFETIMES USING VOTING VIA DIGITAL LEDGERS

(71) Applicant: RED HAT, INC., Raleigh, NC (US)

(72) Inventor: Bilgin Ibryam, London (GB)

(21) Appl. No.: 17/722,627

(22) Filed: Apr. 18, 2022

(51) Int. Cl. G06Q 20/40; G06Q 20/38; G06Q 20/06

(52) U.S. Cl. CPC G06Q 20/405; G06Q 20/407; G06Q 20/389; G06Q 20/065; G06Q 20/401

(57) ABSTRACT

Smart contracts within digital ledger systems can be used in managing lifetimes of software services. For example, a computing system can receive, from client devices, cryptocurrency transactions. Each cryptocurrency transaction can be a vote regarding a lifetime of a software service. The computing system can publish the cryptocurrency transactions to a digital ledger. The computing system can determine that a number of cryptocurrency transactions exceeds a predetermined threshold. In response to determining that the number of cryptocurrency transactions exceeds a predetermined threshold, the digital ledger can retain the cryptocurrency transactions for use in extending the lifetime of the software service.

### TECHNICAL FIELD

The present disclosure relates generally to digital ledgers. More specifically, but not by way of limitation, this disclosure relates to managing software services using digital ledgers.

### BACKGROUND

A blockchain is a shared, decentralized digital ledger that can facilitate the process of recording transactions and tracking asset ownership. A blockchain contains a sequential series of immutable records referred to as “blocks.” Each block is distinct from the block before it and is linked to the prior block via a hashed pointer, thereby creating a sequential chain of blocks or “blockchain.” The immutability of the blocks allows the blockchain to serve as a trusted record of transactions. A blockchain can be distributed across a set of connected devices (e.g., nodes) that can each have a copy of the blockchain. When a transaction is attempted, the nodes can use their own copies of the blockchain to collectively reach a consensus about the validity of the transaction. These distributed consensus mechanisms can make falsifying transactions challenging and impractical, because a false transaction would be flagged by the nodes and rejected. By contrast, a traditional recordation system relies on the trustworthiness of a single party, which can make falsifying transactions easier.

In some instances, the blockchain may include smart contracts. A smart contract is a self-executing contract or self-enforcing agreement in the form of executable program code, which can be stored on the blockchain and executed by one or more nodes. Unlike traditional contracts, where one party may change its mind or renege on a contract, smart contracts can be automatically executed in response to certain inputs or events.

### BRIEF DESCRIPTION OF THE DRAWINGS

FIG. 1 is a block diagram of an example of a system for managing a software service lifetime using digital ledgers according to some aspects of the present disclosure.

FIG. 2 is a block diagram of another example of a system for managing a software service lifetime using digital ledgers according to some aspects of the present disclosure.

FIG. 3 is a flow chart of an example of a process for managing a software service lifetime using digital ledgers according to some aspects of the present disclosure.

### DETAILED DESCRIPTION

It can be difficult to determine when to discontinue some or all features of a software service. Relatively older software services may be implemented using outdated or inefficient software and hardware, which may increase the latency and reduce overall computer performance for computing systems hosting the software services. Older software services may have relatively higher security risks, and may consume a disproportionate amount of computing resources for the number of clients utilizing the software services. But it can be difficult to determine client interest in continuing to provide a software service. For example, subscriptions to software services may be automatically renewed each year, with little to no client feedback regarding the importance of the software service in a client organization. Paradoxically, the longer a software service has been provided, the harder it may be to replace in a client organization. In some instances, a client may request that removed features or components of a software service be re-implemented. But re-inserting the removed features into an upgraded version of the software service can be challenging, as combining features from potentially incompatible versions of the software service can negatively impact the performance of the computing system that is hosting the software service.

Some examples of the present disclosure can overcome one or more of the abovementioned problems by managing software service lifetimes via voting in a digital ledger network. Client devices may vote on an extension of a lifetime of a software service by transmitting a cryptocurrency transaction that is published to a digital ledger network, such as a blockchain. In some examples, a number of cryptocurrency transactions stored in the digital ledger network exceeds a predetermined threshold. Exceeding the predetermined threshold can indicate that there is sufficient interest in the software service to justify extending the lifetime of the software service, and the cryptocurrency transactions can be retained for use in extending the lifetime of the software service. If the predetermined threshold has not been exceeded after a predetermined voting time period has ended, some or all features of the software service may be discontinued. Discontinuing some or all features of a software service may reduce the latency and increase the processing power of a computing system that is providing the software service. Additionally, some or all features of the software may be upgraded to improve the efficiency and security of the computing system. Alternatively, determining interest in the software service before terminating the software service may prevent having to re-implement a discontinued software service if the removal of the software service is causing issues for a client.

In one particular example, the digital ledger network can be a distributed database that is duplicated and shared across a network of computer nodes that collectively validate (e.g., approve or reject) transactions. One example of such a digital ledger network can include a blockchain, though other types of distributed digital ledgers can be used. A blockchain is a shared, decentralized digital ledger that can facilitate the process of recording transactions and tracking asset ownership. A blockchain contains a sequential series of immutable records referred to as “blocks.” When a vote for extending a lifetime of the software service is received from a client device in the form of a cryptocurrency transaction, the nodes may validate the transaction and store the cryptocurrency transaction in a block. If the total amount of cryptocurrency transactions exceeds the predetermined threshold, the lifetime of the software service may be extended. Additionally, all cryptocurrency transactions received from client devices may be retained for use in maintaining the software service.

If the predetermined threshold for cryptocurrency transactions is exceeded, a smart contract in the digital ledger system can be executed to retain the cryptocurrency transactions for use in extending the lifetime of the software service. In some examples, a client device may use its cryptographic token to redeem a portion of a renewal fee for the software service based on the value of the cryptocurrency transaction. Alternatively, all cryptographic transactions may be automatically deposited towards renewal fees for the client devices that transmitted the cryptographic transactions. If a user of a client device that transmitted a cryptocurrency transaction decides against renewing the software service, their cryptocurrency transaction may not be returned to the client device. If the predetermined threshold for the cryptocurrency transactions is not exceeded, such as after the predetermined time period has ended, a smart contract in the digital ledger system may be executed to return all cryptographic transactions to their corresponding client devices.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

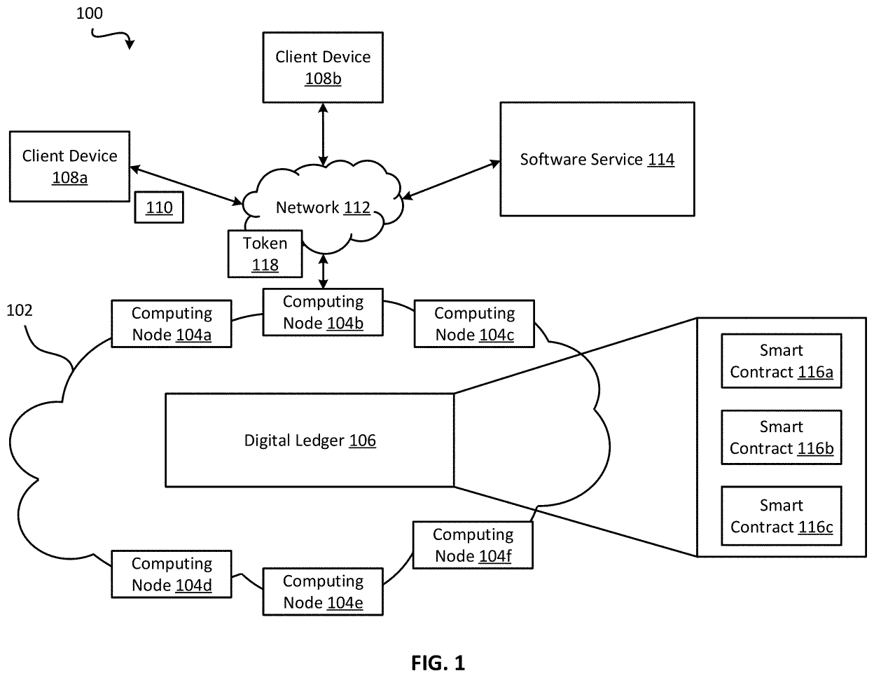

FIG. 1 is a block diagram of an example of a system 100 for managing a lifetime of a software service 114 using smart contracts according to some aspects of the present disclosure. The system 100 can include a digital ledger network 102 that can include a digital ledger 106 and any number and combination of computing nodes, such as computing nodes 104a-f. Examples of the computing nodes 104a-f can include desktop computers, servers, and specialized mining computers such as application-specific integrated circuit (ASIC) miners. The computing nodes 104a-f can collectively implement the digital ledger network 102 to host the digital ledger 106, which in this example is a distributed digital ledger. One example of the digital ledger network 102 can be a blockchain network in the context of a blockchain. The computing nodes 104a-f may be distributed among and operated by one or more participants of the digital ledger network 102.

The digital ledger 106 can provide an immutable record related to cryptocurrency transactions. To facilitate use of the digital ledger 106, the computing nodes 104a-f can each have access to a respective copy of the digital ledger 106 and can user their respective copies to validate transactions on the digital ledger 106. In some examples, the computing nodes 104a-f can validate transactions by consensus, in which a new record is only added to the digital ledger 106 if many (e.g., a majority) of the computing nodes 104a-f agree that the record should be added. The computing nodes 104a-f may employ one or more consensus algorithms to reach such a consensus. Examples of the consensus algorithms can include proof of work, proof of stake, practical byzantine fault tolerance, proof of burn, proof of history, proof of reputation, or combinations thereof.

One or more client devices 108a-b can interact with the digital ledger network 102 to vote on an extension of a lifetime of a software service 114. Examples of the client devices 108a-b can include a mobile device, laptop computer, desktop computer, or server. A client device 108 can interact with the digital ledger network 102 via one or more networks 112, such as a local area network or the Internet. For example, the client device 108 can transmit one or more cryptocurrency transactions 110 to the digital ledger network 102. An example of the cryptocurrency transactions 110 can include Bitcoin. In some examples, the cryptocurrency transactions 110 can be stablecoin cryptocurrency. Transmitting the cryptocurrency transaction 110 can indicate that a user of the client device 108 prefers for the lifetime of the software service 114 to be extended. The computing nodes 104a-f can validate the cryptocurrency transaction 110, such as by using the aforementioned consensus algorithms. The validated cryptocurrency transaction 110 can be published to the digital ledger 106.

The digital ledger network 102 may include smart contracts 116a-c that can be automatically executed in response to certain conditions being met. The smart contracts 116a-c may be stored in any suitable location that is accessible to the digital ledger network 102. For example, some or all of the smart contracts 116a-c may be stored on the digital ledger 106. Additionally or alternatively, some or all of the smart contracts 116a-c may be stored in a database external to the digital ledger network 102. Regardless of their location, the smart contracts 116a-c can be accessed and executed by the digital ledger network 102. In some examples, the smart contracts 116a-c may be executed by one computing node 104a of the digital ledger network 102. In other examples, the smart contracts 116a-c may be executed by two or more of the computing nodes 104a-f working in cooperation.

For example, a user of the client device 108a may want their cryptocurrency transaction 110 to be an anonymously cast vote. In response to receiving a cryptocurrency transaction 110, a smart contract 116a can execute program code to automatically generate a cryptographic token 118. In some examples, the cryptographic token 118 can be a non-fungible token (NFT). The digital ledger network 102 can transmit the cryptographic token 118 to the client device 108a. The cryptographic token 118 can represent a value of the cryptocurrency transaction 110. Because the cryptographic tokens 118 are distributed to the client devices 108a-b to redeem the value of the cryptocurrency transactions 110, the cryptocurrency transactions 110 may be anonymously published in the digital ledger 106 in a way that does not identify the origin of a particular cryptocurrency transaction 110.

Additionally, a smart contract 116b may be used to determine ownership of the cryptocurrency transactions 110. In one example, the number of cryptocurrency transactions 110 may exceed a predetermined threshold, indicating that a sufficient number of client devices 108a-b desire access to the software service 114. Exceeding the predetermined threshold may trigger an action by the smart contract 116b. For example, the smart contract 116b can include program code that is executable to transfer ownership of the cryptocurrency transactions 110 to the owner of the software service 114 in response to a number of cryptocurrency transactions 110 received from the client devices 108a-b exceeding the predetermined threshold. In some examples, ownership of the cryptocurrency transactions 110 may be transferred by the smart contract 116b to a digital wallet associated with the owner of the software service 114. The retained cryptocurrency transactions 110 can be used by the owner of the software service 114 to extend the lifetime of the software service 114.

Alternatively, the number of cryptocurrency transactions 110 may indicate a lack of sufficient client devices 108a-b that desire access to the software service 114. For example, the client devices 108a-b may transmit cryptocurrency transactions 110 during a predetermined voting time period. After the predetermined voting period is over and if a number of cryptocurrency transactions 110 does not exceed the predetermined threshold, a smart contract 116c may be automatically executed to return the cryptocurrency transactions 110 to the client devices 108a-b. Additionally, the lifetime of the software service 114 may not be extended, and the software service 114 may be disabled. In some examples where the client devices 108a-b received a cryptographic token 118 in exchange for the cryptocurrency transaction 110, the client devices 108a-b may redeem the cryptographic tokens 118 for the value of the cryptocurrency transaction 110.

In some examples where the lifetime of the software service 114 is extended, a smart contract 116 such as smart contract 116a can additionally alert the client devices 108a-b of the extension. The client device 108a can transmit a request to redeem the cryptographic token 118 received from the digital ledger network 102 for a portion of a renewal fee for the software service 114. The system 100 can then waive the portion of the renewal fee for the client device 108a. In some examples, a user of the client device 108b may not desire to renew the software service 114. After transmitting the alert of the extension, the digital ledger network 102 may receive a request to cancel a renewal of the software service 114 from the client device 108b. The system 100 can then cancel the renewal for the client device 108b. In some examples, the system 100 may retain the cryptocurrency transaction 110 received from the client device 108b for use in extending the lifetime of the software service 114, even if the client device 108b cancels their renewal to the software service 114.

In some examples, the cryptocurrency transactions 110 can be an upgrade vote for determining if the software service 114 should be upgraded. Users of some client devices 108a-b may utilize the current features of the software service 114 and may prefer for the current features to be preserved rather than upgraded. Client devices 108a-b may transmit cryptocurrency transactions 110 to the digital ledger network 102 to indicate that a potential upgrade for the software service 114 should not be implemented. If the number of cryptocurrency transactions 110 exceeds the predetermined threshold, a smart contract such as smart contract 116b can retain the cryptocurrency transactions 110 to be used in maintaining the software service 114 with the current features. Additionally, the potential upgrade for the software service 114 can be canceled or delayed.

Although FIG. 1 shows a certain number and arrangement of components, this is intended to be illustrative and non-limiting. Other examples may include more components, fewer components, different components, or a different arrangement of components shown in FIG. 1. For instance, the client devices 108a-b may be part of the digital ledger network 102. Any suitable arrangement of the depicted components is contemplated herein.

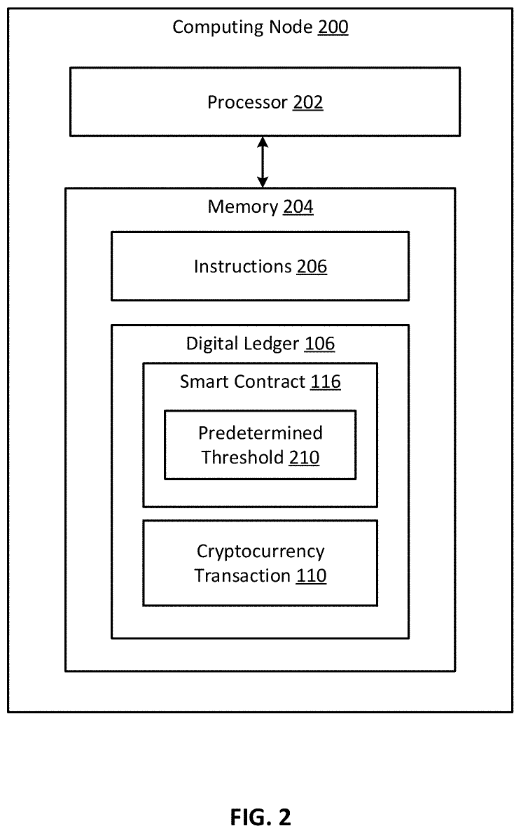

FIG. 2 is a block diagram of a computing node 200 for managing a lifetime of a software service 114 using smart contracts 208 according to some aspects of the present disclosure. The computing node 200 includes a processor 202 communicatively coupled to a memory 204. In some examples, the computing node 200 can be any of the computing nodes 104a-f of FIG. 1.

The processor 202 can include one processor or multiple processors. Non-limiting examples of the processor 202 include a Field-Programmable Gate Array (FPGA), an application-specific integrated circuit (ASIC), a microprocessor, etc. The processor 202 can execute instructions 206 stored in the memory 204 to perform operations. In some examples, the instructions 206 can include processor-specific instructions generated by a compiler or an interpreter from code written in any suitable computer-programming language, such as C, C++, C#, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. In some examples, at least some of the memory can include a medium from which the processor 202 can read instructions 206. A computer-readable medium can include electronic, optical, magnetic, or other storage devices capable of providing the processor 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the memory 204 may include a digital ledger 106. The processor 202 may receive a cryptocurrency transaction 110 from a client device 108. The cryptocurrency transaction 110 may be a vote representing that a user of the client device 108 wishes for a lifetime of the software service 114 to be extended. The processor 202 may validate the cryptocurrency transaction 110 and may publish the cryptocurrency transaction 110 to the digital ledger 106. The digital ledger 106 can include smart contracts 116 that can be automatically executed when certain conditions are met. For example, when a number of cryptocurrency transactions 110 exceeds a predetermined threshold 210, a smart contract 116 can be executed to retain the cryptocurrency transactions 110 for use in extending the lifetime of the software service 114. Alternatively, if the predetermined threshold 210 is not exceeded, a smart contract 116 can be executed to return the cryptocurrency transactions 110 back to the client devices 108.

In some examples, the cryptocurrency transactions 110 can be received from the client devices 108a-b during a predetermined voting time period. In some examples, the number of received cryptocurrency transactions 110 may not exceed a threshold number after the voting time period expires. A smart contract 116 may be automatically executed to return the cryptocurrency transactions 110 to the client devices 108a-b, as the predetermined threshold not being exceeded during the voting time period can indicate that there is not sufficient demand for extending the lifetime of the software service 114.

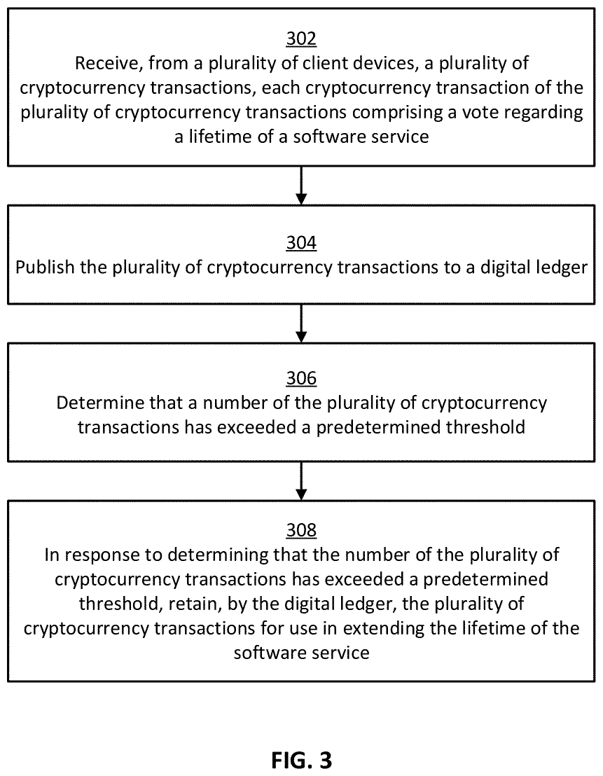

In some examples, the processor 202 can implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processor 202 can receive, from multiple client devices 108a-b, cryptocurrency transactions 110. Each cryptocurrency transaction 110 can be a vote regarding a lifetime of a software service 114. The client devices 108a-b may transmit the cryptocurrency transactions 110 during a predetermined voting time period. Examples of the predetermined voting time period can be a week or a month. The client devices 108a-b may transmit the cryptocurrency transactions 110 after being alerted by the system 100 that the software service 114, or certain components or features of the software service 114, may be discontinued. In some examples, the client devices 108a-b can determine a value of their transmitted cryptocurrency transactions 110. Users of client devices 108a-b may increase the value of their cryptocurrency transactions 110 to increase the odds of extending the lifetime of the software service 114. Alternatively, the client devices 108a-b may be required by the digital ledger network 102 to transmit cryptocurrency transactions 110 with a predetermined value.

At block 304, the processor 202 can publish the cryptocurrency transactions 110 to a digital ledger 106. For example, a smart contract 116 in the digital ledger 106 can publish the cryptocurrency transaction 110 to the digital ledger 106. The processor 202 can validate the cryptocurrency transactions 110 before publishing the cryptocurrency transaction 110, such as by collectively verifying the cryptocurrency transactions 110 via multiple computing nodes 104a-f. In some examples where the digital ledger 106 is a blockchain, each cryptocurrency transaction 110 can be added to the blockchain as a separate block. In some examples, the smart contract 116 can generate a cryptographic token 118 that represents a value of a cryptocurrency transaction 110 received from a client device 108a. The digital ledger network 102 can transmit the cryptographic token 118 to the client device 108a.

At block 306, the processor 202 can determine that a number of cryptocurrency transactions 110 has exceeded a predetermined threshold 210. In some examples, the predetermined threshold 210 can be a number of cryptocurrency transactions 110. Alternatively or additionally, the predetermined threshold 210 can be a percentage of a maintenance cost for the software service 114, and the predetermined threshold 210 may be exceeded if the total value of all cryptocurrency transactions exceeds the maintenance cost. In other examples, the predetermined threshold 210 can be a percentage of a renewal cost for a client device 108 to renew the software service 114 for an upcoming year.

At block 308, in response to determining that the number of cryptocurrency transactions 110 has exceeded the predetermined threshold 210, the processor 202 can retain the cryptocurrency transactions 110 for use in extending the lifetime of the software service 114. For example, the processor 202 can execute a smart contract 116 in the digital ledger 106 to retain the cryptocurrency transactions 110. In some examples, the smart contract 116 may be automatically executed to transfer ownership of the cryptocurrency transactions 110 to an owner of the software service 114. For example, the cryptocurrency transactions 110 can be transferred to a digital wallet associated with the owner of the software service 114. In some examples, a client device 108b may transmit a cryptocurrency transaction 110 to the digital ledger network 102 and the cryptocurrency transactions 110 may exceed the predetermined threshold 210. If a user of the client device 108b reverses their decision and decides against renewing the software service 114, the client device 108b may request a cancellation of their renewal of the software service 114. But, the cryptocurrency transaction 110 transmitted by the client device 108b may not be returned to the client device 108b. The retained cryptocurrency transaction 110 may be used to maintain the software service 114.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any example(s) described herein can be combined with any other example(s) to yield further examples.

1. A system comprising:
a processor; and
a memory including instructions that are executable by the processor for causing the processor to:
receive, from a client device of a plurality of client devices, a cryptocurrency transaction of a plurality of cryptocurrency transactions, each cryptocurrency transaction of the plurality of cryptocurrency transactions comprising a vote regarding a lifetime of a software service;
publish the plurality of cryptocurrency transactions to a digital ledger;
determine that a number of the plurality of cryptocurrency transactions exceeds a predetermined threshold; and
in response to determining that the number of the plurality of cryptocurrency transactions exceeds the predetermined threshold, retain, by the digital ledger, the plurality of cryptocurrency transactions for use in extending the lifetime of the software service.

2. The system of claim 1, wherein the memory further comprises instructions that are executable by the processor for causing the processor to retain the plurality of cryptocurrency transactions by executing a smart contract in the digital ledger.

3. The system of claim 1, wherein the memory further comprises instructions that are executable by the processor for causing the processor to:
determine that the number of the plurality of cryptocurrency transactions does not exceed the predetermined threshold; and
in response to determining that the number of the plurality of cryptocurrency transactions does not exceed the predetermined threshold, execute a smart contract in the digital ledger to return the plurality of cryptocurrency transactions to the plurality of client devices.

4. The system of claim 1, wherein the memory further comprises instructions that are executable by the processor for causing the processor to:
in response to receiving the cryptocurrency transaction from the client device, transmit a cryptographic token to the client device, the cryptographic token representing a value of the cryptocurrency transaction.

5. The system of claim 4, wherein the memory further comprises instructions that are executable by the processor for causing the processor to:
in response to determining that the number of the plurality of cryptocurrency transactions exceeds the predetermined threshold, alert the plurality of client devices of an extension of the lifetime of the software service;
receive, from a client device of the plurality of client devices, a request to redeem a portion of a renewal fee of the software service using the cryptographic token, the portion corresponding to the value of the cryptocurrency transaction; and
waive the portion of the renewal fee for the client device.

6. The system of claim 1, wherein the memory further comprises instructions that are executable by the processor for causing the processor to:
receive, from a client device of the plurality of client devices, a request to cancel a renewal of the software service;
retain the cryptocurrency transaction of the plurality of cryptocurrency transactions associated with the client device; and
cancel the renewal of the software service for the client device.

7. The system of claim 1, wherein each cryptocurrency transaction of the plurality of cryptocurrency transactions comprises an upgrade vote regarding a potential upgrade for the software service, and wherein the memory further comprises instructions executable by the processor for causing the processor to:
in response to determining that the number of the plurality of cryptocurrency transactions exceeds the predetermined threshold, execute a smart contract in the digital ledger to retain the plurality of cryptocurrency transactions for use in delaying the potential upgrade for the software service.

8. A method comprising:
receiving, from a client device of a plurality of client devices, a cryptocurrency transaction of a plurality of cryptocurrency transactions, each cryptocurrency transaction of the plurality of cryptocurrency transactions comprising a vote regarding a lifetime of a software service;
publishing, by a processor, the plurality of cryptocurrency transactions to a digital ledger;
determining, by the processor, that a number of the plurality of cryptocurrency transactions exceeds a predetermined threshold; and
in response to determining that the number of the plurality of cryptocurrency transactions exceeds the predetermined threshold, retaining, by the digital ledger, the plurality of cryptocurrency transactions for use in extending the lifetime of the software service.

9. The method of claim 8, wherein retaining the plurality of cryptocurrency transactions further comprises executing a smart contract in the digital ledger to retain the plurality of cryptocurrency transactions.

10. The method of claim 8, further comprising:
determining that the number of the plurality of cryptocurrency transactions does not exceed the predetermined threshold; and
in response to determining that the number of the plurality of cryptocurrency transactions does not exceed the predetermined threshold, executing a smart contract in the digital ledger to return the plurality of cryptocurrency transactions to the plurality of client devices.

11. The method of claim 8, further comprising:
in response to receiving the cryptocurrency transaction from the client device, transmitting a cryptographic token to the client device, the cryptographic token representing a value of the cryptocurrency transaction.

12. The method of claim 11, further comprising:
in response to determining that the number of the plurality of cryptocurrency transactions has exceeded the predetermined threshold, alerting the plurality of client devices of an extension of the lifetime of the software service;
receiving, from a client device of the plurality of client devices, a request to redeem a portion of a renewal fee for the software service using the cryptographic token, the portion corresponding to the value of the cryptocurrency transaction; and
waiving the portion of the renewal fee for the client device.

13. The method of claim 8, further comprising:
receiving, from a client device of the plurality of client devices, a request to cancel a renewal of the software service;
retaining the cryptocurrency transaction of the plurality of cryptocurrency transactions associated with the client device; and
canceling the renewal of the software service for the client device.

14. The method of claim 8, wherein each cryptocurrency transaction of the plurality of cryptocurrency transactions comprises an upgrade vote regarding a potential upgrade for the software service, and wherein the method further comprises:
in response to determining that the number of the plurality of cryptocurrency transactions exceeds the predetermined threshold, executing a smart contract in the digital ledger to retain the plurality of cryptocurrency transactions for use in delaying the potential upgrade for the software service.

15. A non-transitory computer-readable medium comprising program code that is executable by a processor for causing the processor to:
receive, from a client device of a plurality of client devices, a cryptocurrency transaction of a plurality of cryptocurrency transactions, each cryptocurrency transaction of the plurality of cryptocurrency transactions comprising a vote regarding a lifetime of a software service;
publish the plurality of cryptocurrency transactions to a digital ledger;
determine that a number of the plurality of cryptocurrency transactions exceeds a predetermined threshold; and
in response to determining that the number of the plurality of cryptocurrency transactions exceeds the predetermined threshold, retain, by the digital ledger, the plurality of cryptocurrency transactions for use in extending the lifetime of the software service.

16. The non-transitory computer-readable medium of claim 15, wherein program code is executable to further cause the processor to retain the plurality of cryptocurrency transactions by executing a smart contract in the digital ledger.

17. The non-transitory computer-readable medium of claim 15, wherein program code is executable to further cause the processor to:
determine that the number of the plurality of cryptocurrency transactions does not exceed the predetermined threshold; and
in response to determining that the number of the plurality of cryptocurrency transactions does not exceed the predetermined threshold, execute a smart contract in the digital ledger to return the plurality of cryptocurrency transactions to the plurality of client devices.

18. The non-transitory computer-readable medium of claim 15, wherein program code is executable to further cause the processor to:
in response to receiving the cryptocurrency transaction from the client device, transmit a cryptographic token to the client device, the cryptographic token representing a value of the cryptocurrency transaction.

19. The non-transitory computer-readable medium of claim 18, wherein program code is executable to further cause the processor to:
in response to determining that the number of the plurality of cryptocurrency transactions exceeds the predetermined threshold, alert the plurality of client devices of an extension of the lifetime of the software service;
receive, from a client device of the plurality of client devices, a request to redeem a portion of a renewal fee for the software service using the cryptographic token, the portion corresponding to the value of the cryptocurrency transaction; and
waive the portion of the renewal fee for the client device.

20. The non-transitory computer-readable medium of claim 15, wherein program code is executable to further cause the processor to:
receive, from a client device of the plurality of client devices, a request to cancel a renewal of the software service;
retain the cryptocurrency transaction of the plurality of cryptocurrency transactions associated with the client device; and
cancel the renewal of the software service for the client device.
